(19) United States
(12) Patent Application Publication
(10) Pub. No.: US 2025/0233836 A1
(43) Pub. Date: Jul. 17, 2025

(54) INTEGRATED MESSAGING AND DATA APPLICATIONS

(71) Applicant: REALTIME MANUFACTURING LLC, Sammamish, WA (US)

(72) Inventors: John Flynn, Sammamish, WA (US); Cory Flynn, Sammamish, WA (US)

(21) Appl. No.: 19/017,343

(22) Filed: Jan. 10, 2025

Related U.S. Application Data
(60) Provisional application No. 63/620,694, filed on Jan. 12, 2024.

(51) Int. Cl. H04L 51/04

(52) U.S. Cl. CPC H04L 51/04

(57) ABSTRACT

Aspects generally relate to messaging applications and more specifically to an integrated messaging and data application that displays relevant data alongside messaging features and prompting the user to look at the pertinent data when viewing or responding to messages.

### CROSS REFERENCE TO RELATED APPLICATION

This application claims the benefit of U.S. Provisional Application No. 63/620,694, entitled INTEGRATED MESSAGING AND DATA APPLICATIONS and filed on Jan. 12, 2024. U.S. Provisional Application No. 63/620,094 is incorporated by reference in its entirety.

### BACKGROUND

Generally described, computing devices and communication networks can be utilized to exchange data or information. In a common application, a computing device can request content from another computing device via the communication network. For example, a client, or transmitting device, can utilize a software application to exchange data with a server computing device via the network (e.g., the Internet).

In some applications, a network service provider can instantiate various network-based services that can process requests for data or data processing. For example, network-services related to data analysis and performance metric processing can receive information related to the operation of computing devices, execution of software applications, user interactions, and the like.

### BRIEF DESCRIPTION OF THE DRAWINGS

Embodiments of various inventive features will now be described with reference to the following drawings. Throughout the drawings, reference numbers may be re-used to indicate correspondence between referenced elements. The drawings are provided to illustrate example embodiments described herein and are not intended to limit the scope of the disclosure. To easily identify the discussion of any particular element or act, the most significant digit(s) in a reference number typically refers to the figure number in which that element is first introduced.

FIG. 1 depicts a block diagram of an environment for a data processing system that includes one or more network services;

FIG. 2 is a block diagram of illustrative components of a data processing system in accordance with at least some embodiments disclosed herein;

FIG. 3 is a flow diagram illustrative of a routine for the processing of information in accordance with aspects of the present application; and

FIG. 4 is a block diagram illustrative of a display page illustrating data viewports and messaging viewports in accordance with aspects of the present application.

### DETAILED DESCRIPTION

Generally described, one or more aspects of the integrated messaging and data application described herein combines messaging functionality with data presentation to streamline user communication. Illustratively, aspects of the present application include functionalities to display pertinent data alongside messaging data (e.g., ongoing conversations), encouraging users to reference and respond to messages in context with the relevant information or otherwise including relevant information in responsive messages.

A prevalent challenge across industries reliant on online document and data sharing involves efficiently tracking and organizing related communication. For instance, consider a scenario where an automobile tire supplier procures tires from a manufacturer and conducts multiple performance tests during the manufacturing process to ensure safety and quality standards. Throughout this process, various data and documents concerning the tire's performance may be generated, collected, or otherwise exchanged. This data may include access to various software applications, data systems, data stores, software services, etc.

In some applications, the need for different types of data or the association of different types of data can vary based on progress according to a set of interactions (e.g., a workflow). In some scenarios, individual pieces of data may be applicable/relevant to multiple interactions of the set of interactions. Additionally, different groupings or combinations of data may also vary according to specific progress states with the set of interactions. In one example, companies utilize network-based services, generally referred to as cloud platforms, for file sharing and email for communication. However, retrieving specific data and related conversations—such as requested improvements regarding the previously mentioned performance tests—from email archives becomes cumbersome over time. For example, retaining copies of the same document/email/attachment can increase memory requirements for computing systems. This can yield to inefficient transactions or the inclusion of erroneous or incorrect information as part of a process or workflow. Still further, some portions of data/messages may be associated with different authentication/authorization requirements depending on specific progress within a workflow. Still further, such inefficiencies can cause increases in the utilization of processing and memory resources. Accordingly, simply combining discreet components, such as stand-alone messaging systems, stand-alone project management systems, etc., does not yield benefits of integrated systems.

The described application addresses this challenge by integrating a messaging thread system directly linked to data topics. By associating communication threads with specific data topics, all involved parties gain access to discussions. Moreover, authorized personnel granted access to this platform can efficiently retrieve and review these interactions, ensuring comprehensive visibility and streamlined retrieval of pertinent information. Additional aspects and benefits may also be realized.

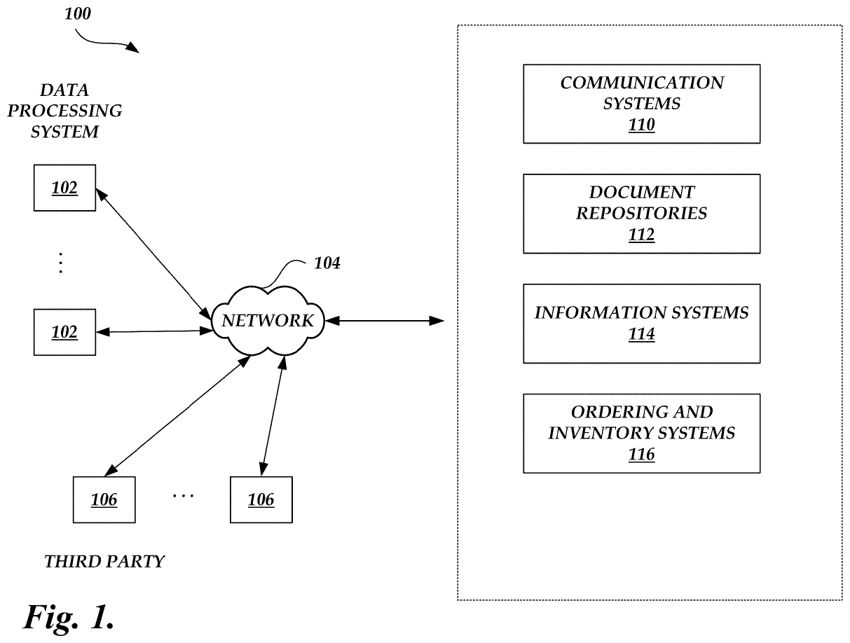

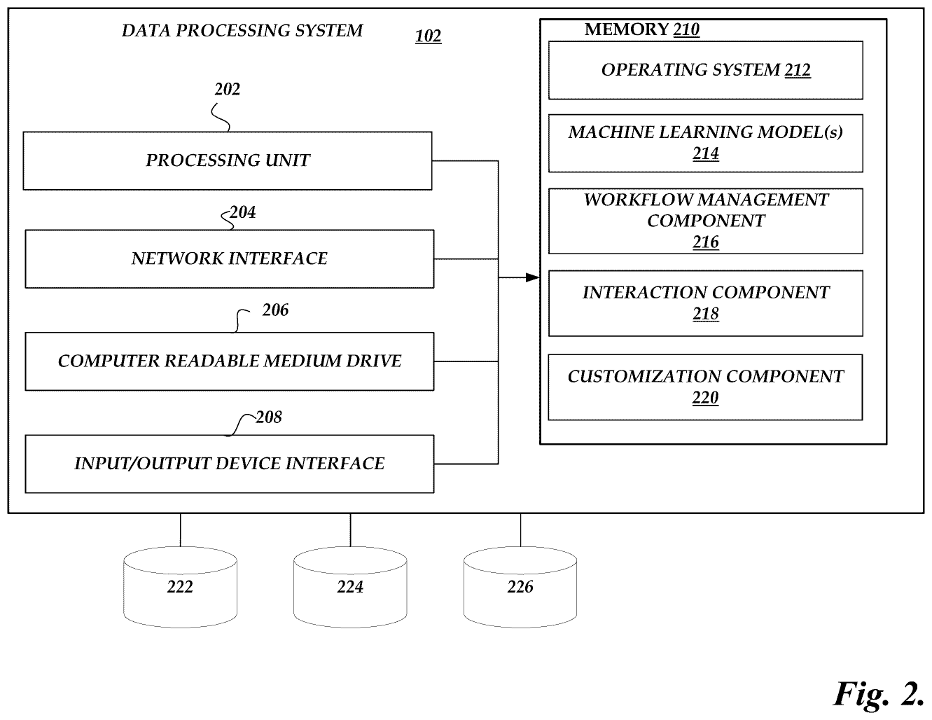

FIG. 1 depicts a block diagram of an embodiment of an environment 100 for implementation of one or more aspects of the present application. The environment 100 can include a data processing system 102 for processing inputs, collecting data, generating data or other functionality as described herein without limitation. An illustrative architecture for the data processing system 102 will be described below with regard to FIG. 2.

The environment 100 further includes a communication network 104 for allowing the data processing system 102 to communicate with various computing systems or other network services 106. Network 104, as depicted in FIG. 1, connects the devices and modules of the system. The network can connect any number of devices. The network 104 may be a personal area network, local area network, wide area network, over-the-air broadcast network (e.g., for radio or television), cable network, satellite network, cellular telephone network, or combination thereof. As a further example, the network 104 may be a publicly accessible network of linked networks, possibly operated by various distinct parties, such as the Internet. In some embodiments, the network 104 may be a private or semi-private network, such as a corporate or university intranet. The network 104 may include one or more wireless networks, such as a Global System for Mobile Communications (GSM) network, a Code Division Multiple Access (CDMA) network, a Long-Term Evolution (LTE) network, or any other type of wireless network. The network 102 can use protocols and components for communicating via the Internet or any of the other aforementioned types of networks. For example, the protocols used by the network 102 may include Hypertext Transfer Protocol (HTTP), HTTP Secure (HTTPS), Message Queue Telemetry Transport (MQTT), Constrained Application Protocol (CoAP), and the like. Protocols and components for communicating via the Internet or any of the other aforementioned types of communication networks are well known to those skilled in the art and, thus, are not described in more detail herein.

In some embodiments, the data processing system 102 generates various outputs according to a workflow as described herein. The data processing system 102 can access additional information sources, such as additional third-party computing devices 106, communication systems 108, document repositories 110, information systems 112, data processing systems 114, ordering and inventory systems 116 and the like. Such additional information sources are illustrative in nature and should not be construed as limiting. Additionally, the identification of such additional systems does not indicate that such systems would be required. The data processing system 102 may access the systems through the communication network 104.

FIG. 2 illustrates an embodiment of an architecture, for example, a data processing system 102 utilized to implement one or more aspects of the present disclosure. The data processing system 102 is configured to perform various data management and display management functions associated with a defined workflow. The general architecture of the data processing system 102 depicted in FIG. 2 includes an arrangement of computer hardware and software components that may be used to implement aspects of the present disclosure. As illustrated, the data processing system 102 includes a processing unit 202, a network interface 204, a computer-readable medium drive 206, and an input/output device interface 208, all of which may communicate with one another by way of a communication bus. The components of the data processing system 102 may be physical hardware components or implemented in a virtualized environment.

The processing unit 202 can include general-purpose central processing units (CPUs), which are generally adapted for executing one or few instructions at a time, and tensor processing units (TPUs), which may be specially adapted for handling the demanding computations for training neural networks, such as deep learning tasks, and also may include graphics processing units (GPUs), which contain hundreds or thousands of co-processors that compute instructions in parallel, for example, to perform artificial intelligence algorithm provided by machine learning model(s). The data processing system 102 can be processed by implementing various logic circuitries configured to perform the processing operation of the processing unit 202 based on executable commands generated from the memory 210. The present disclosure does not limit the types and numbers of the processing unit and logic circuitry.

The network interface 204 may provide connectivity to one or more networks or computing systems, such as the network 106 of FIG. 1. The processing unit 202 may thus receive information and instructions from other computing systems or services via the network. The processing unit 202 may also communicate to and from memory 210 via the input/output device interface 208. In some embodiments, the forensic service 114 may include more (or fewer) components than those shown in FIG. 2.

The memory 210 may include computer program instructions that the processing unit 202 executes in order to implement one or more embodiments. The memory 210 generally includes RAM, ROM, or other persistent or non-transitory memory. The memory 210 may store an operating system 212 that provides computer program instructions for use by the processing unit 202 in the general administration and operation of the forensic service 114. The memory 210 may further include computer program instructions and other information for implementing aspects of the present disclosure. In some embodiments, the processing unit 202, the network interface 204, the computer-readable medium drive 206, the input/output device interface 208, and the memory 210 can be integrated as an integrated circuit chip, such as silicon on chip. In some examples, these components can be integrated as an application specific integrated circuit.

The memory 210 may include one or more machine learning models that assist in processes associated with the identified tasks or subtasks performed by, or otherwise associated with, the data processing system 102. In some examples, the machine learning models can be utilized to identify the context, priority, or relevancy of a set of available messages to different interaction in a set of interactions (e.g., a workflow). For example, machine learned models may be able to analyze metadata in some examples. In other examples, the machine learning models may be trained on historical data from past usage of the data processing system 102.

A variety of machine learning models may be utilized within the machine learning models for training and generating outputs. These models can include large language models and various other types, such as supervised learning models, unsupervised learning models, semi-supervised learning models, reinforcement learning models, deep learning models, and ensemble learning models. Specific examples of models that may be employed include logistic regression models, decision trees, random forests, convolutional neural networks, deep neural networks, and others. Other possible models include linear regression models, discrete choice models, and generalized linear models.

The machine learning algorithms may be configured to adaptively develop and update the models over time based on new inputs received by the machine learning models. Non-limiting examples of machine learning algorithms that can be used to generate and update parameter functions or prediction models include supervised and unsupervised algorithms, such as regression algorithms (e.g., Ordinary Least Squares Regression), instance-based algorithms (e.g., Learning Vector Quantization), decision tree algorithms (e.g., classification and regression trees), Bayesian algorithms (e.g., Naive Bayes), clustering algorithms (e.g., k-means clustering), association rule learning algorithms (e.g., Apriori algorithms), artificial neural networks (e.g., Perceptron), deep learning algorithms (e.g., Deep Boltzmann Machines), dimensionality reduction algorithms (e.g., Principal Component Analysis), and ensemble algorithms (e.g., Stacked Generalization), among others.

With specific reference to FIG. 2, in some embodiments, the memory 210 can include a workflow management component 216. Illustratively, the workflow management component configured with a set of specification interactions defined according to individual workflows. The memory 210 can also include an interaction component 218. Illustratively, the interaction component 218 defines a messaging viewport and a data viewport for individuation interactions in the set of interactions. Additionally, the memory 210 can include a customization component 220. The customization component 220 customizes at least one of the messaging viewport or the data viewport. The data processing system 102 may also access various data stores to facilitate interaction, such as workflow data store 222, messaging data store 224 and profile data store 224.

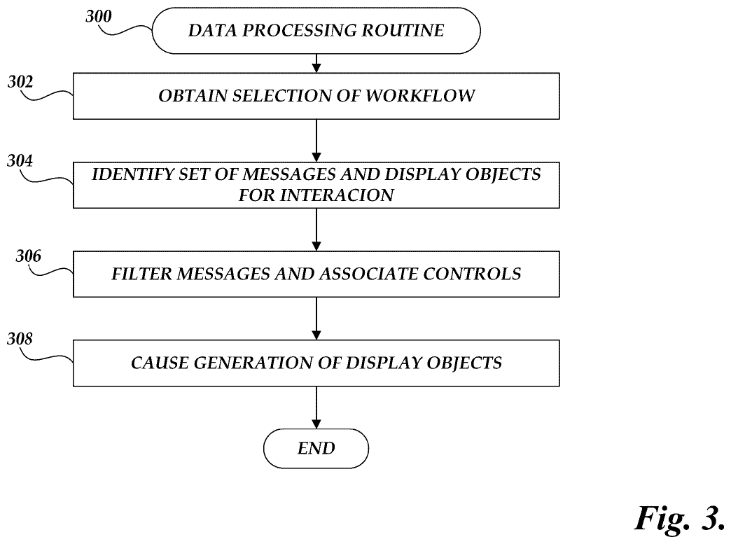

FIG. 3 is a flow diagram illustrative of a routine 300 for the processing of information and generation of display objects in accordance with aspects of the present application. Illustratively, routine 300 describes interactions of the data processing system 102 in managing the display of information associated with implementation of a selected workflow. Workflows generally include any number of processes or interactions in which a user accesses information, provides inputs or information, etc. Each illustrative interaction may be associated with a specific set of a combination of required information, optional information, user interactions, user prohibitions.

At block 302, the data processing system 102 obtains a selection of a workflow. As previously indicated, the workflow defines a set of interactions that correspond to an identified topic/selection. For example, a manufacturing process related to the manufacture or procurement of fashion items, industrial components, etc. The workflow may be selected according to various user interaction methods, such as graphical user interface controls (e.g., drop down menus). For example, an organization may associated individual purchase orders (POs) as separate workflows. Accordingly, a user may be presented with one or more user interfaces that identifies all the outstanding POs for potential selection by an administrator/user. These interfaces can also include information identifying the individual PO, previous access information, percentage completion, etc. Additionally, the interfaces can also identify, such as icons, colors, or other indicators, POs that require some form of user interaction. In still other embodiments, the workflow may be selected based on user authentication and identification methods, such as login information, account information, transaction identifiers, location information, and the like. Other methods for identification may also be incorporated.

At block 304, the data processing system 102 identifies a set of messages from an available set of messages and additional display objects for presentation. In one embodiment, the data processing system 102 can utilize various interfaces/interactions to access a messaging system, such as an Application Programming Interface (API). The interface can specify search information or selection information to generate the set of available messages. In other embodiments, the data processing system 102 may previous maintain copies or links to messaging systems that does not require external access. Accordingly, the data processing system 102 can apply additional filtering or processing to select the available set of messages.

Illustratively, the individual messages in the set of messages are associated with metadata. The metadata can provide additional context related to the content of the message, the creator of the message, or its preassigned applicability to various steps of the workflow (or specific interactions in set of interactions). In one embodiment, the metadata may be in the form of a multi-dimensional array that associates messages with various display objects (e.g., different aspects of an interaction or different interactions). Additional information regarding the multi-dimensional array will be described below.

At block 306, the data processing system 102 filters the set of messages based on at least one of relevancy or priority for individual interactions in the set of interactions. Illustratively, the data processing system 102 can implement various types of filtering processes for determining which messages to display, such as by processing the metadata, the message content, the message attributes or various combinations. In one embodiment, the data processing system 102 can process the messages according to programmatic rules, such as parsing the metadata that may already identify relevancy or priority. In another embodiment, the data processing system 102 can incorporate machine learned algorithms that have been trained to review the inputs (e.g., metadata, message content, message attribute, etc.) and filter messages. The machine learned algorithms may be trained on historical information regarding previous implementation of workflows.

In another embodiment, the data processing system 102 can process messages according to an authenticated user role or access parameter. Illustratively, the data processing system 102 can remove duplicate messages or consolidate messages to limit the number of messages that are selected in the filtering process. Additionally, the data processing system 102 can also associate access control parameters or restrictions, such as via profile or instructions associated with a template.

In still other embodiments, the data processing system 102 can filter messages to eliminate messages that have incorrect information, information that has been corrected/updated, information that has otherwise been identified as not to be displayed. For example, the data processing system 102 can utilize flags or other identifiers that facilitate identification of information of a sensitive or confidential nature. In another example, the data processing system 102 can associate specific privileges to messages based on association with roles (e.g., legal counsel), specific individual, organizational affiliation (e.g., external party), and the like.

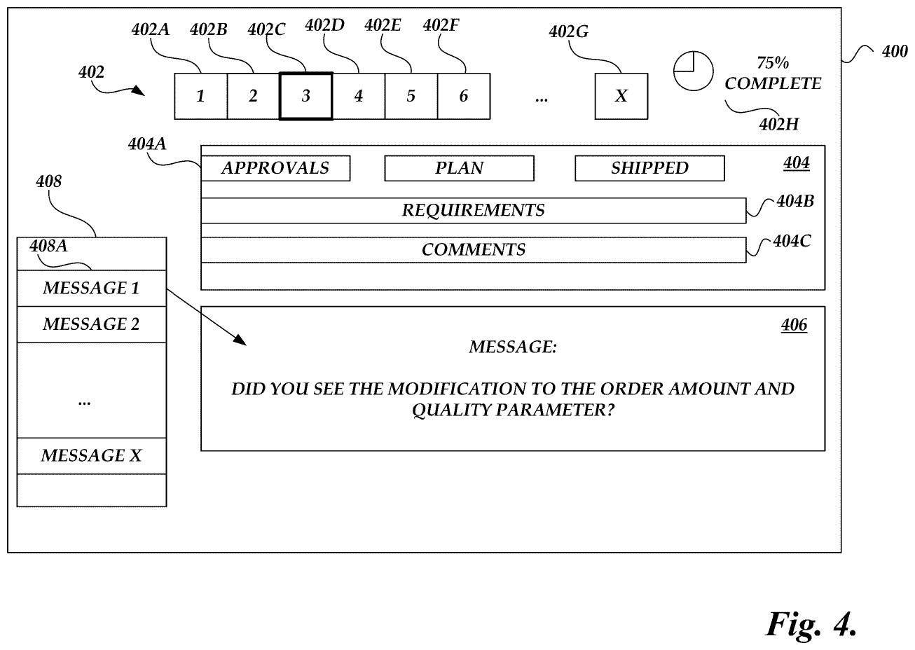

At block 308, the data processing system 102 causes the generation of a display including a combination of data viewports and messaging viewports. The messaging viewports correspond to the filtered set of messages. Illustratively, the display of the viewports and message viewports provide necessary access to data (e.g., documents, messages, etc.) that is required as appropriate and relevant for various steps/stages of the interactions. This can mitigate the display of irrelevant or incorrect messages or information. Additionally, it can facilitate the generation of new data (e.g., new messages or documents) that can incorporate necessary information. In some embodiments, the display can also prohibit or limit the creation or modification of data, such as limit message generation functionality that has been designed at not allowable. Still further, in some embodiments, the display can also be configured to provide status information regarding progress of a workflow, estimated time to completion of individual interactions or the workflow, cost estimates, total participation time, scoring information, and the like. Various embodiments of the generated display and interactions will be described with regard to FIG. 4. Additional functionality of the display will also be described. At block 301, the routine 300 terminates.

Illustratively, in some embodiments, the data processing system 102 optimizes user productivity by consolidating messaging features and data representation within a unified interface. The homepage displays a central dashboard, featuring a structured table that shows at least a selected subset of projects (FIG. 4).

With reference to FIG. 4, within individual project pages 400 (e.g., a workflow), multiple interactions for an identified workflow (or set of interaction) can be organized as a set of tabs 402 (e.g., tabs 402A, 402B, 402C, 402D, 402E, 4022F, 042G), establishing a hierarchical structure for data organization. Illustratively, a tab 402 can be generally referred to as a topic, although such designation does not require any specific meaning or purpose to the individual tab. Each individual interactions illustratively offer two distinct viewports, a data viewport 404 and a messaging viewport 406, fostering contextual engagement during communication and facilitating streamlined navigation across various data subsets. In the illustrative example of FIG. 4, tab 402C has been selected. A topic's name, order, and permission sets are customizable by one or more individual users, such as a creator of the topic, administrator, or other designated individual(s), as well as the data inputs within the data viewport. The tabs 402 can also include a percentage completion indicator 402H for the selected topic/tab (e.g., 402C).

The data viewport 404 can be configured to incorporate custom data tables, document folders, and images or PDFs. This enables users to construct data structures tailored to the topic and sequence these data structures to reflect a coherent workflow. For example, data can be stored directly in a data object (or set of objects) that are configured to define the attributes or aspects of the topic data object. Illustratively, rows 404A, 404B and 404C illustrate summary information or user input controls for the selected tab (e.g., 402C).

The messaging viewport 406 serves as a comprehensive display for a subset of messages originating from the corresponding topic page. Illustratively, the subset of messages can include all the messages related to the topic or a selected set sorted by various organizational criteria (e.g., time-filters, subject matter filters, author filters, etc.). These messages are searchable and filterable, optimizing the efficiency of locating desired messages. Every message sent from a topic's messaging viewport stores a direct reference to the topic's ID in the message metadata. This topic ID reference serves as a secondary index in the message database, facilitating the retrieval and presentation of all messages sent from that topic's page in the messaging viewport. Illustratively, the data processing system 102 does not need to maintain a copy of each message associated with a topic to eliminate the need for redundant storage and potential errors/inconsistencies.

In accordance with illustrative aspects, the interface and associated systems can include additional controls and logic to prevent individuals from specific actions related to the message. For example, the data processing system 102 can implement control logic that, when implemented, limits messaging functionality so that users can send messages only through a topic page's messaging viewport 406. This ensures that the user views all related messages and data while composing a new message. As will be explained below, additional interfaces or pages (or subpages) can be configured to allow for viewing messages only (without additional messaging functionality). Additionally, the interfaces can also be configured to automatically direct users wishing to utilize messaging functionality (e.g., composing, responding, forwarding messages) to the messaging viewport. This allows the logic to remain consistent while allowing users to have access to the desired messaging functionality.

Both projects and topics possess distinct sets of permissions embedded within their data, establishing links between each user and specific read or write permissions via user ID references. Regarding projects, users can be associated with various authentication and authorization credentials (e.g., read permissions) to gain access to that project's basic data (e.g. name, creator, description) which is displayed in the central dashboard. Other authentication and authorization credentials (e.g., write permissions) for a project wield the authority to allocate permissions for the project and its associated topics. Additionally, authentication and authorization credentials can possess information necessary to modify the structure of data elements, such as altering table column names or incorporating a document folder into the topic page. Regarding topics, users with read permissions gain access to that topic's name, data, and associated messages, and the ability to send new messages. Authorization and authentication credentials, including write permissions can manipulate data values within the data viewport, such as modifying a table's data cell or uploading a document to a document folder, but they cannot modify the structure of data elements unless permitted in the project permissions.

Consider a practical scenario illustrating one of the application's use cases: a company engaged in manufacturing swimsuits tailored for a particular buyer. Throughout the manufacturing process, meticulous communication between the manufacturer and buyer is crucial to ensure the precise fulfillment of the buyer's specifications. Utilizing this application, the manufacturer creates a dedicated project and grants the buyer read access to messages.

Within the project interface, the manufacturer establishes distinct topics, or tabs, representing various phases of the manufacturing process, such as fitting, testing, packaging, among others. The manufacturer then grants read access to the buyer for the necessary topics. Each topic facilitates the compartmentalization of data pertinent to specific aspects while concurrently housing an associated messaging thread.

For instance, if specific tests are conducted on the product, resulting reports are entered into a custom data table within that topic's data viewport. The resulting reports can be displayed to all future viewers of the page. To empower buyers with the ability to supplement additional data on this topic page, the manufacturer can grant them write access to the testing topic. Corresponding discussions or communications relevant to this data are segregated and presented in the messaging viewport. This is made possible by the reference to the parent topic's ID stored in the metadata of every message sent from this topic page.

Expanding on the application's functionality, users possess the capability to correlate messages directly with specific data points. For instance, if testing data indicates a lower thread count than anticipated, the buyer can select this specific data point within the data viewport and link it to a new message regarding the deviation from the expected standards. This action generates and stores metadata pointing to the thread count data point in the message's data object. Consequently, any user revisiting this page can filter messages linked to the thread count data by right clicking the data in the data viewport and requesting to filter. This will filter the messaging viewport to show only messages that's metadata contains a reference to the thread count data. This streamlines the review process by directing focus solely on communications referencing this specific data point.

The application also features a centralized repository 408 known as the general mailbox, which aggregates and partially displays messages from all projects the user has access to. The consolidated mailbox provides users with a comprehensive view of ongoing activities across all projects the user has permissions to at least view, enabling them to respond promptly without the need to search through individual project topics. However, users cannot send messages from this page. As illustrated in FIG. 4, the contents of message 408A is provided as relevant to tab 402C.

General Mailbox. The messages on this page originate from various projects, referred to as PO's in this table.

This solution effectively consolidates data, documents, and communication into a unified platform, mitigating the need for extensive search efforts to locate project-specific documents and related communications.

### Split-Screen Interface for Data and Messaging

Illustrative embodiments of the messaging application employ a split-screen layout, presenting two viewports: one displaying relevant data and the other showcasing the messaging mailbox and tools (FIG. 2). This design mandates users to view the data stored in the topic data object concurrently while interacting with messages that contain a reference to this topic's ID in their metadata. Users navigate messages or compose responses in the messaging viewport while the adjacent data viewport continuously displays the relevant data. This enforced co-presence encourages users to consider displayed data when engaging with messages, enhancing contextual understanding and decision-making within our application.

### Data Format & Templates

Illustrative embodiments of the messaging application provide users with the capability to customize the formatting of data within each topic. Users who have write permissions (e.g., requisite authentication and authorization credential) for specific projects can create and apply custom formats for all data elements present on individual topics within the interface. Data elements include custom data tables, document folders, images, and charts, and are stored in a nested data structure within their parent topic's data object.

Further, users can save these customized formats as templates for future use. These templates serve as predefined configurations for structuring and presenting topic data and can be shared with other users. Users can conveniently reuse these saved templates when creating a new project, ensuring consistency and efficiency in data formatting across the application. In some embodiments, the data processing system 102 can provide access to allow templates to be utilized for resale/distribution, such as a template marketplace or sharing resource.

### Data Reference Encoded in Messages

Illustrative embodiments of the messaging application enable users to encode direct references to specific displayed data within their messages. When composing a message, users interact with displayed data elements by clicking or highlighting them in the data viewport. This interaction facilitates the encoding of highlighted data elements as direct references within the message body using embedded metadata.

Illustratively, individual message data can be associated with information organized according to a multi-dimensional array. Each value in the multi-dimensional array corresponds to, or is otherwise associated with, a display object. By way of illustrative example, the multi-dimensional array may be a three-dimensional array in which individual array elements correspond to specific data fields on the page. Specifically, in a three-dimensional array of integers, each integer represents an index pointing to aspects of the displayed viewport, such as table, row, then column, respectively. For example, if a table (e.g., display object) is the second element on the page following the filebox (e.g., another display object), the array values for a message associated with the table would be [1, −1, −1]. Metadata values to reference the first row in that table would be [1, 0, −1] and for the first column [1, −1, 0]. In this illustrative example, the −1 value represents a wildcard, meaning all existing values are referenced here.

In some embodiments, the multi-dimensional array can also be used to point to files. For example, assume a file box is the first element on the page (e.g., viewport). Metadata associating a message to the document would include array values of [0, 0, −2]. The −2 represents that there is no deeper data structure to be referenced.

This metadata not only allows the messaging component to highlight relevant data on the page when viewing a message, but it also allows the messaging application to filter the messages based on if they are contained in a set on the page. For example, when a user selects ‘filter by this row’ when viewing a table on a tab and the messaging application will show all messages containing metadata [1, 0, X], where X represents any value. Similarly, prioritization and relevancy sorting by the messaging component to identify and sort according to metadata.

### Message Mailbox Filtering by Data:

Utilizing the encoded data references within messages, users can employ these references as filters to refine their messaging viewport. This can be done by right-clicking on the desired element in the data and choosing to filter messages by data. Consequently, the messages are dynamically filtered to exhibit only messages referencing the chosen data or its subsets. This feature enhances organizational capabilities within the messaging viewport by enabling precise categorization of messages based on referenced data elements.

### Prioritized Mailbox Sorting:

Integrated within the encoding of data references in messages, our application offers users a prioritized sorting view in their general mailbox (FIG. 3). Messages containing encoded references to date-related information are algorithmically sorted chronologically. This sorting mechanism arranges messages from the furthest date in the past to the furthest in the future, providing users with an organized view of relevant communication based on the referenced temporal data within messages.

### Special Permissions Delegation

Our application offers users the capability to granularly manage read and write permissions for individual topics, their data, and their data structures. Users possess the authority to specify permissions, deciding which other users can view and edit each project as well as each designated topic within a project. The permission to read a project denotes that the user can see basic information about that project while the permission to write it denotes that the user can modify, add, remove, or rename topics, and modify the data layout on those topic pages. The permission to read a topic denotes that the user can view the data on that topic page and send messages linked to that page, while the permission to write it gives access to editing data within the data layout but not the layout itself (e.g. the thread count value but not the column value thread count). These permissions are stored in the data structure of every project and topic as a list of user ID's.

Additionally, users hold the ability to delegate another user with special permissions. This delegation empowers users to select a different user to receive all their messages temporarily and confer permissions to all projects and topics. Users can define the duration for which this delegated user will have access to their messages and permissions, ensuring control and flexibility over data access and messaging interactions within the application.

### Progress Information

As previously described, in some embodiments, the display 400 can also be configured to provide status information regarding progress of a workflow, estimated time to completion of individual interactions or the workflow, cost estimates, total participation time, scoring information, and the like. For example, the data processing system 102 can implement programmatic rules or machine learned algorithms that can generate one or more progress information.

Without limitation, illustrative embodiments of the messaging and data application seamlessly blend messaging features with data representation, improving user interaction. The split-screen interface ensures simultaneous visibility of data and messages, facilitating contextual understanding during communication.

Through customizable data formatting, templates, data reference encoding, mailbox filtering, prioritized sorting, and special permissions delegation, users gain enhanced control and efficiency in data management and associated dialogues. This application signifies a significant stride in user productivity, enabling seamless communication and informed decision-making through integrated data and messaging functionalities within a unified interface.

Although aspects of the present disclosure will be described with regard to illustrative network components, language models, interactions, and routines, one skilled in the relevant art will appreciate that one or more aspects of the present disclosure may be implemented in accordance with various environments, system architectures, customer computing device architectures, and the like. Similarly, references to specific data structures/models, such as a transformer and a log, can be considered to be general references and not intended to provide additional meaning or configurations for individual data structures. Additionally, the examples are intended to be illustrative in nature and should not be construed as limiting.

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

All of the processes described herein may be fully automated via software code modules, including one or more specific computer-executable instructions executed by a computing system. The computing system may include one or more computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

The various illustrative logical blocks and modules described in connection with the embodiments disclosed herein can be implemented or performed by a machine, such as a processing unit or processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor can be a microprocessor, but in the alternative, the processor can be a controller, microcontroller, or state machine, combinations of the same, or the like. A processor can include electrical circuitry configured to process computer-executable instructions. In another embodiment, a processor includes an FPGA or other programmable device that performs logic operations without processing computer-executable instructions. A processor can also be implemented as a combination of customer computing devices, e.g., a combination of a DSP and a microprocessor, a plurality of microprocessors, one or more microprocessors in conjunction with a DSP core, or any other such configuration. Although described herein primarily with respect to digital technology, a processor may also include primarily analog components. A computing environment can include any type of computer system, including, but not limited to, a computer system based on a microprocessor, a mainframe computer, a digital signal processor, a portable customer computing device, a device controller, or a computational engine within an appliance, to name a few.

Conditional language such as, among others, “can,” “could,” “might,” or “may,” unless specifically stated otherwise, are otherwise understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without customer input or prompting, whether these features, elements and/or steps are included or are to be performed in any particular embodiment.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached figures should be understood as potentially representing modules, segments, or portions of code that include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B, and C” can include a first processor configured to carry out recitation A working in conjunction with a second processor configured to carry out recitations B and C.

What is claimed is:

1. A system, the system comprising:
a workflow management component, implemented on one or more computing devices including a processing component and a memory, the workflow management component configured with a set of specification interactions defined according to individual workflows;
an interaction component, implemented on one or more computing devices including a processing component and a memory, the interaction component defining a messaging viewport and a data viewport for individuation interactions in the set of interactions; and
a customization component, implemented on one or more computing devices including a processing component and a memory, the customization component customizing at least one of the messaging viewport or the data viewport.

2. The system as recited in claim 1, wherein the messaging viewport corresponds to a subset of a set of available messages filtered according to at least one of relevancy or priority for individual interactions in the set of interactions.

3. The system as recited in claim 2, wherein the interaction component filters the set of available messages based on programmatic rules.

4. The system as recited in claim 2, wherein the interaction component filters the set of available messages based on role of a user accessing the system.

5. The system as recited in claim 2, wherein the interaction component filters the set of available messages based on machine learned algorithms.

6. The system as recited in claim 2, wherein individual messages of the set of available messages are associated with metadata, the metadata defining associations with display objects.

7. The system as recited in claim 6, wherein the metadata is defined according to a multi-dimensional array, wherein individual dimensions of the multi-dimensional array corresponds to a display object.

8. The system recited in claim 1, wherein the templates define custom display properties for individual interactions in the set of interactions.

9. A computer-implemented method, the method comprising:
obtaining a selection of a workflow, the workflow defining a set of interactions;
identifying a set of messages from an available set of messages, wherein individual messages in the set of messages are associated with metadata;
filtering the set of messages based on at least one of relevancy or priority for individual interactions in the set of interactions; and
causing the generation of a display including a combination of data viewports and messaging points, the messaging viewports corresponding to the filtered set of messages.

10. The method of claim 9, wherein filtering the set of messages based on at least one of relevancy or priority for individual interactions in the set of interactions includes filtering the set of available messages based on programmatic rules.

11. The method as recited in claim 9, wherein the metadata is defined according to a multi-dimensional array, wherein individual dimensions of the multi-dimensional array corresponds to a display object.

12. The method of claim 9, wherein filtering the set of messages based on at least one of relevancy or priority for individual interactions in the set of interactions includes filtering the set of available messages based on user access parameters.

13. One or more computer-readable media comprising instructions that, when executed by a computing system, causes the computing system to:
identify a set of messages from an available set of messages, wherein individual messages in the set of messages are associated with metadata;
filter the set of messages based on at least one of relevancy or priority for individual interactions in the set of interactions; and
cause the generation of a display including a combination of data viewports and messaging points, the messaging viewports corresponding to the filtered set of messages.

14. The computer-readable medium as recited in claim 13, wherein the computing system identifies the set of available messages based on a specified workflow.

15. The computer-readable medium as recited in claim 14, wherein the specified workflow is defined according to a set of interactions.

16. The computer-readable medium as recited in claim 13, wherein the computing system filters the set of available messages based on programmatic rules.

17. The computer-readable medium as recited in claim 13, wherein the metadata is defined according to a multi-dimensional array, wherein individual dimensions of the multi-dimensional array corresponds to a display object.

18. The computer-readable medium as recited in claim 13, wherein the computer system filters the set of available messages based on user access parameters.

19. The computer-readable medium as recited in claim 13, wherein computer system limits modifications to the set of available messages.

20. The computer-readable medium as recited in claim 13, wherein the computer system identifies progress in a workflow.
